(19) United States
(12) Patent Application Publication
(10) Pub. No.: US 2020/0182216 A1
(43) Pub. Date: Jun. 11, 2020

(54) OUTBOARD MOTOR HAVING IDLING STOP FUNCTION

(71) Applicant: SUZUKI MOTOR CORPORATION, Hamamatsu-shi (JP)

(72) Inventor: Yukihiro YOSHIKAWA, Hamamatsu-shi (JP)

(73) Assignee: SUZUKI MOTOR CORPORATION, Hamamatsu-shi (JP)

(21) Appl. No.: 16/701,350

(22) Filed: Dec. 3, 2019

(30) Foreign Application Priority Data
Dec. 6, 2018 (JP) 2018-229281

(51) Int. Cl. F02P 5/15; B63H 20/00; F02P 1/08; F16H 59/22; F16H 59/10

(52) U.S. Cl. CPC F02P 5/1508; B63H 20/001; F16H 59/105; F16H 59/22; F02P 1/086

(57) ABSTRACT

An outboard motor having an idling stop function, which includes a starter motor configured to start up an engine, a capacitor configured to serve as a power source of the starter motor, a restarting circuit that includes a restart switch configured to activate the starter motor by electric power supplied from the capacitor in conjunction with a shift lever directly operated by a ship operator at a time of restarting after idling stop, a changeover switch configured to switch to an idling stop mode that enables the restarting circuit, and an engine control device configured to control shifting to the idling stop in the idling stop mode. The capacitor is disposed in an engine compartment of the outboard motor.

### CROSS-REFERENCE TO RELATED APPLICATIONS

This application is based upon and claims the benefit of priority of the prior Japanese Patent Application No. 2018-229281, filed on Dec. 6, 2018, the entire contents of which are incorporated herein by reference.

### FIELD OF THE INVENTION

The present invention relates to an outboard motor having an idling stop function.

### BACKGROUND

There are batteryless outboard motors not equipped with batteries as small-sized outboard motors. Japanese Laid-open Patent Publication No. 2013-199851 discloses an outboard motor that includes no battery but drives engine accessories by using electric power generated when an engine is driven.

In recent years, the need for batteryless outboard motors to have an idling stop function has been increased due to enhanced awareness of environmental issues.

However, in order for the batteryless outboard motor to have the idling stop function, an external power supply is required to drive a starter motor and an engine control device. However, when the outboard motor includes the external power supply, a problem that the outboard motor is upsized will arise.

In addition, for example, when a user enjoys fishing on a ship equipped with an outboard motor, the user may prefer drift-fishing in which the user continues to fish while letting the ship drift on the tide. During the drift-fishing, since the idling stop function is repeatedly performed, restarting with a simple operation is desired. Further, when causing the engine to shift from a stopped state to an operating state during the drift-fishing, it is only necessary to move the hull forward or backward with a low-load propulsion power to control the orientation thereof. Hence, it is desirable that the restarting is feasible with an operation for realizing such a low-load propulsion power.

### SUMMARY OF THE INVENTION

In view of the above-mentioned problems, the present invention intends to make it possible to miniaturize an outboard motor even in the case of having the idling stop function.

An outboard motor according to the present invention has an idling stop function. The outboard motor includes an electric starter configured to start up an engine, a capacitor configured to supply electric power to the electric starter, a restarting circuit that includes a restart switch configured to activate the electric starter by electric power supplied from the capacitor in conjunction with an operation part directly operated by a ship operator at a time of restarting after idling stop, a changeover switch configured to switch to an idling stop mode that enables the restarting circuit, and a control unit configured to control shifting to the idling stop in the idling stop mode, wherein the capacitor is disposed in an engine compartment of the outboard motor.

### BRIEF DESCRIPTION OF THE DRAWINGS

FIG. 1 is a left-side view illustrating an exemplary configuration of an outboard motor.

FIG. 2 is a right-side view illustrating an exemplary configuration of a steering handle.

FIG. 3 is a diagram illustrating an exemplary configuration of an outboard motor body seen from the front side.

FIG. 4 is a cross-sectional diagram illustrating an exemplary configuration of the inside of a gear case.

FIG. 5 is a diagram illustrating an exemplary circuit configuration of the outboard motor.

FIG. 6 is a flowchart illustrating an exemplary operation of the outboard motor.

### DETAILED DESCRIPTION OF THE PREFERRED EMBODIMENTS

An embodiment according to the present invention includes a starter motor 54 for starting up an engine 18, a capacitor 55 serving as a power source of the starter motor 54, a restarting circuit having a second start switch 59 for activating the starter motor 54 with electric power supplied from the capacitor 55 in conjunction with a shift lever 36 directly operated by a ship operator at the time of restarting after idling stop, a changeover switch 32 for switching to an idling stop mode that enables the restarting circuit, and an engine control device 50 for controlling the shifting to idling stop in the idling stop mode. The capacitor 55 is disposed in an engine compartment 17a of an outboard motor 10.

According to the outboard motor 10 according to the present embodiment, since the capacitor 55 serving as the power source of the starter motor 54 is disposed in the engine compartment 17a of the outboard motor 10, the outboard motor 10 can be miniaturized even in the case of having the idling stop function.

### EXAMPLES

Hereinafter, details of the present embodiment will be described with reference to attached drawings.

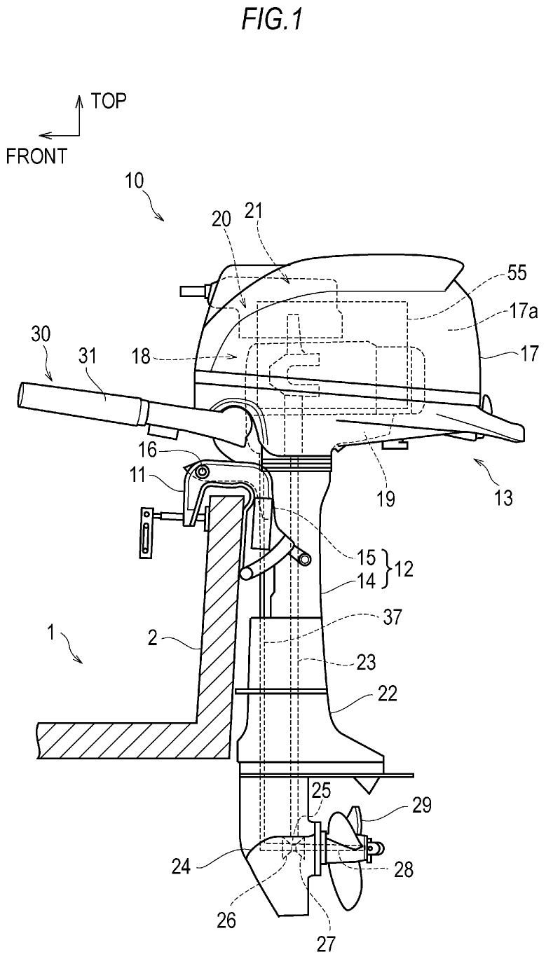

FIG. 1 is a left-side view illustrating an exemplary configuration of the outboard motor 10. In the following drawings including FIG. 1, if necessary, with the state in which the outboard motor 10 is attached to a hull 1 as a reference, the front side is indicated by an arrow “FRONT” and the opposite side is referred to as the rear side. Further, the left side is indicated by an arrow “LEFT” and the opposite side is referred to as the right side. Moreover, the upper side of the outboard motor 10 is indicated by an arrow “TOP” and the opposite is referred to as the lower side. The front side is the same as the advancing direction of the hull 1.

As illustrated in FIG. 1, the outboard motor 10 is attached to a transom board 2 of the hull 1. The outboard motor 10 includes a pair of right and left clamp brackets 11, a swivel bracket 12 that is tiltable with respect to the clamp brackets 11 in the vertical direction, and an outboard motor body 13. The clamp bracket 11 is fixed to the upper end of the transom board 2. The swivel bracket 12 has a cylindrical body part 14 extending in the vertical direction and a rotary part 15 extending forward from the upper end of the body part 14. The rotary part 15 is pivotally supported by the clamp brackets 11 via a tilt shaft 16. Accordingly, the outboard motor body 13 can be tilted up in the vertical direction via the swivel bracket 12 while centering on the tilt shaft 16.

At an upper part of the outboard motor body 13, a vertical type engine 18 as an internal combustion engine is accommodated in an engine cover 17. The inside of the engine cover 17 is configured as the engine compartment 17a. The engine 18 is held by an engine holder 19 disposed on the lower side. A generator 20 is disposed on the upper side of the engine 18, and a recoil starter device 21 is disposed on the upper side of the generator 20. The recoil starter device 21 is an exemplary manual starter. Further, a drive shaft housing 22 is coupled with the lower side of the engine holder 19. The drive shaft housing 22 extends downward in such a way as to penetrate the body part 14 of the swivel bracket 12. The body part 14 of the swivel bracket 12 supports, via a bearing (not illustrated), the drive shaft housing 22 rotatably in the horizontal direction.

A drive shaft 23 extending downward from the engine 18 is accommodated in the drive shaft housing 22. A gear case 24 is coupled with the lower side of the drive shaft housing 22. In the gear case 24, a bevel gear 25, a forward gear 26, a reverse gear 27, a propeller shaft 28, and a shifting device are disposed, so that the rotation of the drive shaft 23 is transmitted to the propeller shaft 28. A propeller 29, which rotates in synchronism with the propeller shaft 28, is coupled with the rear end of the propeller shaft 28.

A steering handle 30 is attached via a handle bracket to the engine holder 19 or the drive shaft housing 22. The steering handle 30 has a substantially bar shape extending in the back and forth direction. A ship operator, by turning the steering handle 30 in the horizontal direction, can turn the drive shaft housing 22 in the same direction, thereby changing the steering angle of the outboard motor body 13.

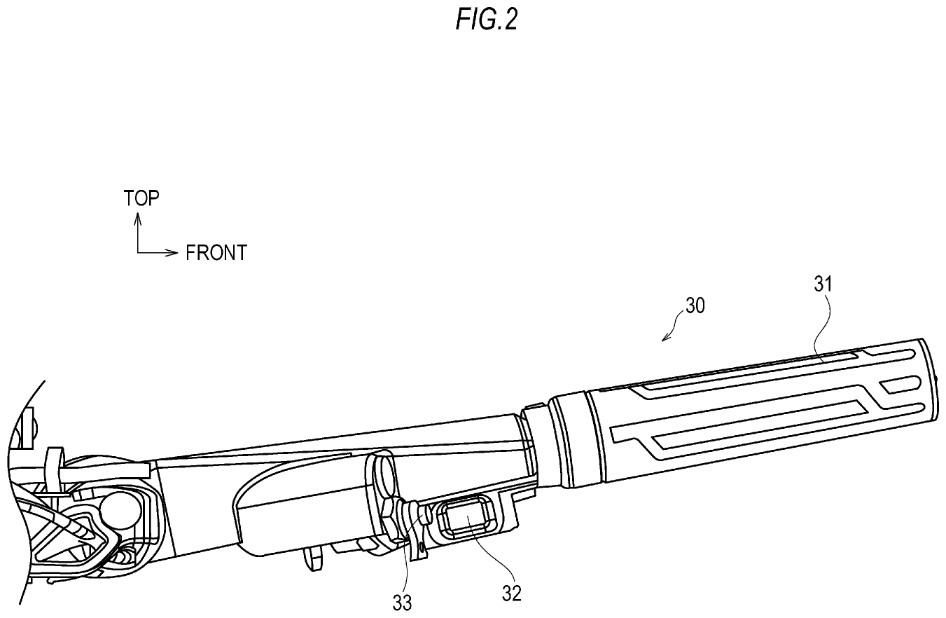

FIG. 2 is a right-side view illustrating an exemplary configuration of the steering handle 30.

The steering handle 30 has a throttle grip 31 at a front end thereof. The throttle grip 31 is rotatable around an axis thereof. The ship operator, by rotating the throttle grip 31, can instruct the engine 18 to increase or decrease the output.

Further, the steering handle 30 has the changeover switch 32 at a position adjacent to the throttle grip 31 and on the rear side of the throttle grip 31. The changeover switch 32 is a switch that can be set to either the idling stop mode that enables the idling stop function or a normal mode that disables the idling stop function.

Further, the steering handle 30 has a stop switch 33 at a position adjacent to the throttle grip 31 and the changeover switch 32 and on the rear side of the changeover switch 32. The stop switch 33 is a switch for stopping the driving of the engine 18. The stop switch 33 used in the present embodiment is an emergency switch that is connected to the ship operator and turns on when the ship operator is positioned away from the outboard motor body 13 by a predetermined distance. However, the stop switch 33 may be a switch that instructs to stop the driving of the engine 18 when pressed by the ship operator.

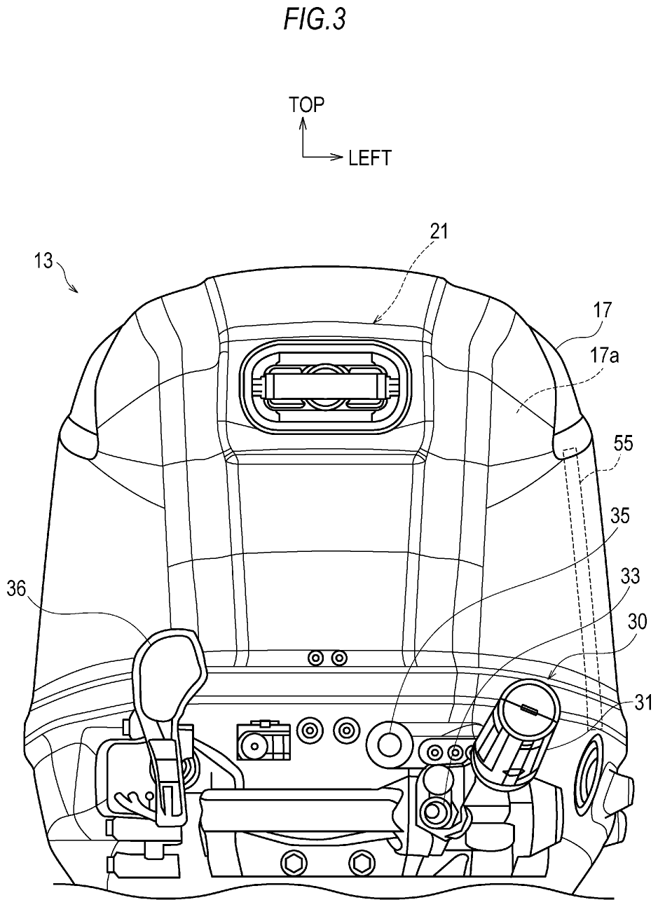

FIG. 3 is a diagram illustrating an exemplary configuration of the outboard motor body 13 seen from the front side.

The outboard motor body 13 has a first start switch (start switch) 35 exposed from a front surface of the engine cover 17. The first start switch 35 is a switch for starting up the engine 18 that is in a completely stopped state.

Further, in the outboard motor body 13, the above-mentioned steering handle 30 is disposed at a position offset left with respect to the center in the right and left direction and the shift lever 36 is disposed at a position offset right. In the present embodiment, the steering handle 30 and the shift lever 36 are symmetrically disposed in the right and left direction. The shift lever 36 is a lever for instructing shift switching. The shift lever 36 according to the present embodiment can instruct Forward when moved to one of upper and lower positions from a neutral position and can instruct Reverse when moved to the other of the upper and lower positions from the neutral position. The shift lever 36 is an exemplary operation part that can be directly operated by the ship operator.

The shift lever 36 is connected to a shift rod 37 extending downward (see FIG. 1). The shift rod 37 is positioned on the front side of the drive shaft 23 and extends until it reaches the inside of the gear case 24. A conversion unit (not illustrated) is provided between the shift lever 36 and the shift rod 37. The conversion unit converts a vertical movement of the shift lever 36 from the neutral position into a horizontal rotation around an axis of the shift rod 37.

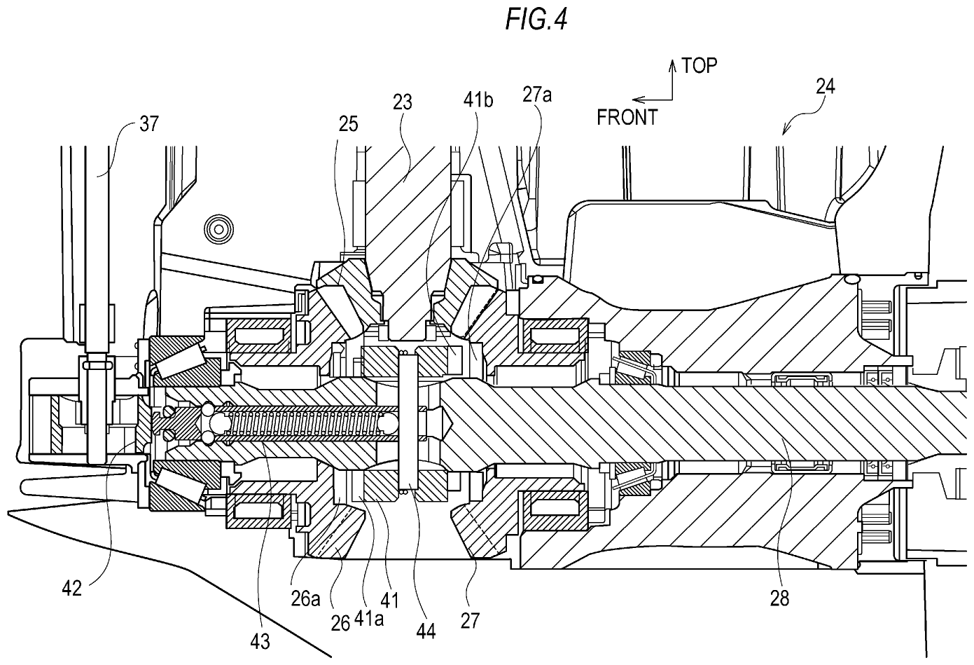

FIG. 4 is a cross-sectional diagram illustrating an exemplary internal configuration of the gear case 24.

In the gear case 24, the forward gear 26 and the reverse gear 27 are rotatably supported so as to be coaxial with the propeller shaft 28 and in a loosely fitted state. The forward gear 26 has a part 26a to be engaged at a rear end thereof, and the reverse gear 27 has a part 27a to be engaged at a front end thereof. The forward gear 26 and the reverse gear 27 constantly mesh with the bevel gear 25 fixed to a lower end of the drive shaft 23.

The propeller shaft 28 is provided with a dog latch 41 that integrally rotates. The dog latch 41 is an exemplary clutch that configures a portion of the shifting device. The dog latch 41 has a substantially hollow cylindrical shape, and is slidable with respect to the propeller shaft 28 by a predetermined stroke along its axial direction. The dog latch 41 is positioned between the forward gear 26 and the reverse gear 27. The dog latch 41 has an engaging part 41a at a front end thereof and an engaging part 41b at a rear end thereof. When the dog latch 41 slides forward from the neutral position illustrated in FIG. 4 and reaches an engagement position on the front side, the engaging part 41a of the dog latch 41 engages with the to-be-engaged part 26a of the forward gear 26. In this case, the dog latch 41 integrally rotates with the forward gear 26. On the other hand, when the dog latch 41 slides backward from the neutral position illustrated in FIG. 4 and reaches an engagement position on the rear side, the engaging part 41b of the dog latch 41 engages with the to-be-engaged part 27a of the reverse gear 27. In this case, the dog latch 41 integrally rotates with the reverse gear 27.

Further, at a lower end of the shift rod 37, a shift yoke (not illustrated) serving as a cam is integrally protruded. The shift rod 37 is in engagement with a shift slider 42 disposed coaxially with the propeller shaft 28 via the shift yoke. When the shift rod 37 rotates leftward or rightward around an axis thereof, the shift yoke pushes the shift slider 42 and the shift slider 42 slides back and forth. The shift slider 42 is connected to the dog latch 41 via a connector rod 43 disposed axially through the propeller shaft 28 and a locking pin 44 disposed in an orthogonal direction.

Accordingly, when the ship operator operates the shift lever 36 to move it from the neutral position to either an upper position or a lower position, the conversion unit converts this movement into rightward or leftward rotation of the shift rod 37, and the shift slider 42 slides either forward or backward.

When the shift slider 42 slides backward, the dog latch 41 engages with the reverse gear 27. The rotation of the drive shaft 23 is transmitted, via the bevel gear 25, the reverse gear 27, and the dog latch 41, to the backward rotation of the propeller shaft 28.

On the other hand, when the shift slider 42 slides forward, the dog latch 41 engages with the forward gear 26. The rotation of the drive shaft 23 is transmitted, via the bevel gear 25, the forward gear 26, and the dog latch 41, to the forward rotation of the propeller shaft 28.

Accordingly, operating the shift lever 36 can switch the rotational shifting between the direction in which the propeller 29 moves forward and the direction in which the propeller 29 moves backward.

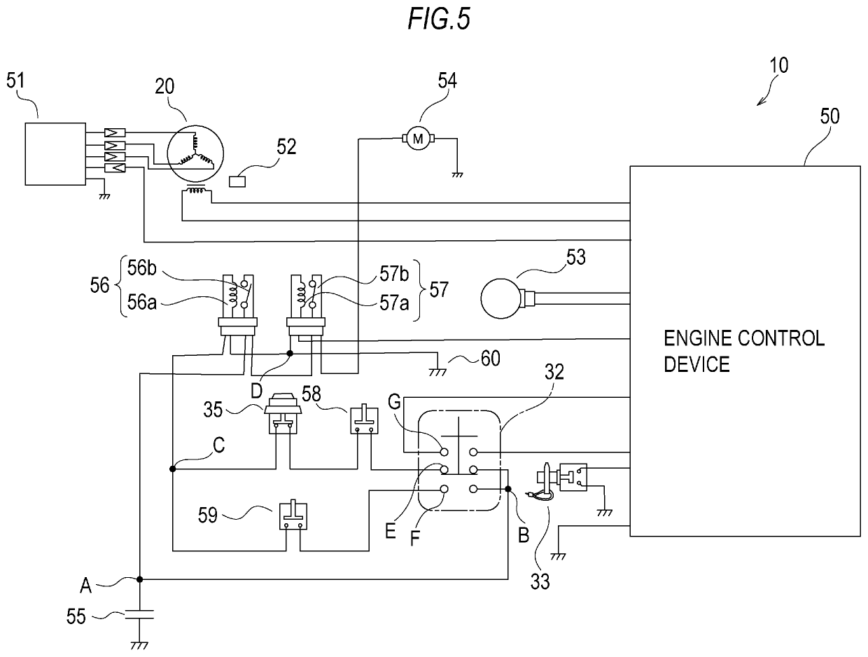

Next, the circuit configuration of the outboard motor 10 according to the present embodiment will be described with reference to FIG. 5. FIG. 5 is a diagram illustrating an exemplary circuit configuration of the outboard motor 10. The same reference numerals are given to the same reference components as those described above. The outboard motor 10 according to the present embodiment is a so-called batteryless outboard motor, which is not equipped with a battery that supplies electric power to engine accessories such as the engine control device 50 described below not only in the completely stopped state of the engine 18 but also in the idling stop state.

As illustrated in FIG. 5, the outboard motor 10 includes the engine control device 50, the generator 20, a regulator/rectifier 51, a crank angle sensor 52, and a throttle position sensor 53.

The engine control device 50 is, for example, an engine control module (ECM), which controls the engine 18 of the outboard motor 10. Specifically, the engine control device 50 controls an ignition device, a fuel injection device, a throttle body, and the like based on an instruction of the ship operator or its own judgement to realize an operating state desired by the ship operator.

Further, when the idling stop mode is set by the changeover switch 32, the engine control device 50 according to the present embodiment controls the shifting to the idling stop in which the engine 18 is temporarily stopped. That is, the engine control device 50 determines whether the conditions for shifting to the idling stop mode are satisfied. When the conditions are satisfied, the engine control device 50 controls each constituent component to shift to the idling stop state. The engine control device 50 is an exemplary control unit.

The generator 20 is connected to the crankshaft of the engine 18 and generates electric power while the crankshaft is rotating. The generator 20 supplies electric power to the engine control device 50 when the engine 18 is operating, and generates no power while the engine 18 is stopped. Accordingly, no electric power is supplied to the engine control device 50 while the engine 18 is stopped.

The regulator/rectifier 51 not only rectifies the electric power generated by the generator 20 into direct current but also performs voltage adjustment.

The crank angle sensor 52 detects the engine speed of the engine 18. The crank angle sensor 52 is an example of speed detection means. The crank angle sensor 52 transmits information on the detected engine speed to the engine control device 50. Based on the received engine speed information, the engine control device 50 controls the engine speed to a target value. The crank angle sensor 52 operates in a state where electric power is supplied from the generator 20.

The throttle position sensor 53 detects the throttle opening degree of a throttle valve disposed in the throttle body. The throttle position sensor 53 is an example of opening degree detection means. The throttle position sensor 53 transmits information on the detected throttle opening degree to the engine control device 50. Based on the received throttle opening degree information, the engine control device 50 controls the intake air amount to a target value. The throttle position sensor 53 operates in a state where electric power is supplied from the generator 20.

The stop switch 33 transmits an ON signal to the engine control device 50. Based on the signal received from the stop switch 33, the engine control device 50 controls the ignition device to stop ignition and controls the fuel injection device to stop fuel injection. Accordingly, turning on the stop switch 33 stops the engine 18. When the engine 18 is stopped, the generator 20 generates no electric power as mentioned above. Therefore, the supply of electric power to the engine control device 50 is also stopped.

The outboard motor 10 has the starter motor 54, the capacitor 55, a starter relay 56, a cutoff relay 57, the first start switch 35, a neutral switch 58, the second start switch 59, and the changeover switch 32.

The starter motor 54 starts up the engine 18 being in the stopped state. The starter motor 54 is an exemplary electric starter. The starter motor 54 forcibly rotates the crankshaft of the engine 18. The outboard motor 10 according to the present embodiment is not equipped with a battery for supplying electric power. Therefore, the engine 18 is started up by supplying electric power generated when the starter motor 54 rotates the crankshaft to the engine control device 50, the ignition device, the fuel injection device, and the like. The starter motor 54 is used when starting up the engine 18 being in the completely stopped state or in the case of starting up the engine 18 from the idling stop state in which the engine 18 is temporarily stopped.

The capacitor 55 is connected to the starter motor 54 and functions as a power source for activating the starter motor 54. The capacitor 55 is charged by the electric power generated by the generator 20. Here, the capacitor 55 has a small electric storage capacity and is small-sized because the capacitor 55 is not used as a power source for driving the engine accessories such as the engine control device 50 and is solely used for supplying electric power to activate the starter motor 54. The capacitor 55 is formed by laminating thin film-like foils, and therefore the degree of freedom in shape is large.

Because of such a small-sized structure, the capacitor 55 is disposed in the engine compartment 17a surrounded by the engine cover 17. Specifically, when seen from the side as illustrated in FIG. 1, the capacitor 55 disposed in the engine compartment 17a is overlapped with the engine 18. Further, when seen from the front as illustrated in FIG. 3, the capacitor 55 is shaped in such a way as to follow the inner surface of the engine cover 17.

The starter relay 56 and the cutoff relay 57 are electrically connected between the starter motor 54 and the capacitor 55.

The starter relay 56 has a coil 56a and a normally open type switch 56b. The starter relay 56 is disposed in such a manner that the switch 56b is serially connected on the side of the capacitor 55 between the starter motor 54 and the capacitor 55.

The cutoff relay 57 has a coil 57a and a normally close type switch 57b. The cutoff relay 57 is disposed in such a manner that the switch 57b is serially connected on the side of the starter motor 54 between the starter motor 54 and the capacitor 55. The switch 57b of the cutoff relay 57 is an exemplary cutoff switch.

Here, since the switch 56b of the starter relay 56 is normally opened and the switch 57b of the cutoff relay 57 is normally closed, when current flows thorough the coil 56a of the starter relay 56, the switch 56b is closed and current flows from the capacitor 55 to the starter motor 54. Accordingly, electric power is supplied from the capacitor 55 to the starter motor 54, and the starter motor 54 is activated. On the other hand, the coil 57a of the cutoff relay 57 is connected to the engine control device 50. Accordingly, when current flows from the engine control device 50 to the coil 57a of the cutoff relay 57, the switch 57b is opened and the supply of electricity from the capacitor 55 to the starter motor 54 is cut off.

The first start switch 35 is closed (turned on) when operated by the ship operator to start up the engine 18 in the completely stopped state.

The neutral switch 58 is closed in a state where the shift lever 36 is in the neutral position.

The first start switch 35 and the neutral switch 58 are serially disposed in a first circuit. Here, the first circuit is a circuit extending from the capacitor 55 to a ground 60 via a branch point A, a branch point B, the changeover switch 32, the neutral switch 58, the first start switch 35, a branch point C, the coil 56a of the starter relay 56, and a branch point D.

The second start switch 59 is closed (turned on) when operated by the ship operator to restart the engine 18 in the idling stop state. The second start switch 59 is an exemplary restart switch. The second start switch 59 is in conjunction with the shift lever 36 serving as the operation part directly operated by the ship operator. Specifically, the second start switch 59 is closed during a switching of the shift lever 36 from the neutral position to the forward or reverse position. More specifically, the second start switch 59 is closed in the middle of a movement range of the dog latch 41 that moves from the neutral position to the engagement position when the shift lever 36 is operated. That is, the second start switch 59 is closed during a sliding movement of the dog latch 41 from the neutral position in accordance with the operated shift lever 36 before the engaging part 41a engages with the to-be-engaged part 26a of the forward gear 26 or before the engaging part 41b engages with the to-be-engaged part 27a of the reverse gear 27.

The second start switch 59 is reopened when the shift switching of the shift lever 36 to the forward or reverse position is completed. More specifically, the second start switch 59 is in a reopened state when the dog latch 41 has completely moved to the engagement position.

For example, this may be realized by a structure in which the second start switch 59 is turned on by a cam interlocked with the operated shift lever 36 while the shift lever 36 moves.

The second start switch 59 is serially disposed in a second circuit. The second circuit is an exemplary restarting circuit. Here, the second circuit is a circuit extending from the capacitor 55 to the ground 60 via the branch point A, the branch point B, the changeover switch 32, the second start switch 59, the branch point C, the coil 56a of the starter relay 56, and the branch point D.

The changeover switch 32 is connected to either the first circuit or the second circuit to enable the first circuit or the second circuit.

Specifically, when the ship operator switches the changeover switch 32 to the normal mode, the changeover switch 32 is connected to a contact E in the first circuit. On the other hand, when the ship operator switches the changeover switch 32 to the idling stop mode, the changeover switch 32 is connected not only to a contact F in the second circuit but also to a contact G in a circuit directly connected to the engine control device 50.

Here, it is assumed that the changeover switch 32 is in the normal mode (the changeover switch 32 is connected to the first circuit) and the engine 18 is in the completely stopped state. In this case, when the ship operator operates the first start switch 35, current flows from the capacitor 55 to the coil 56a of the starter relay 56 via the first circuit. The current flowing through the coil 56a closes the switch 56b of the starter relay 56. Accordingly, electric power is supplied from the capacitor 55 to the starter motor 54, and the starter motor 54 is activated. When the changeover switch 32 is in the normal mode, even if the shift lever 36 is operated to close the second start switch 59, the disconnected state of the second circuit is held by the changeover switch 32. Therefore, no current flows through the coil 56a and the starter motor 54 cannot be activated.

On the other hand, it is assumed that the changeover switch 32 is in the idling stop mode (the changeover switch 32 is connected to the second circuit) and the engine 18 is in the idling stop state. In this case, when the ship operator operates the shift lever 36 from the neutral position to close the second start switch 59, current flows from the capacitor 55 to the coil 56a of the starter relay 56 via the second circuit. The current flowing through the coil 56a closes the switch 56b of the starter relay 56. Accordingly, electric power is supplied from the capacitor 55 to the starter motor 54, and the starter motor 54 is activated. When the changeover switch 32 is in the idling stop mode, even if the first start switch 35 is operated, the disconnected state of the first circuit is held by the changeover switch 32. Therefore, no current flows through the coil 56a and the starter motor 54 cannot be activated. Further, when the changeover switch 32 is in the idling stop mode, the changeover switch 32 is also connected to the circuit (the contact G) directly connected to the engine control device 50. Therefore, the engine control device 50 can detect the switching to the idling stop mode.

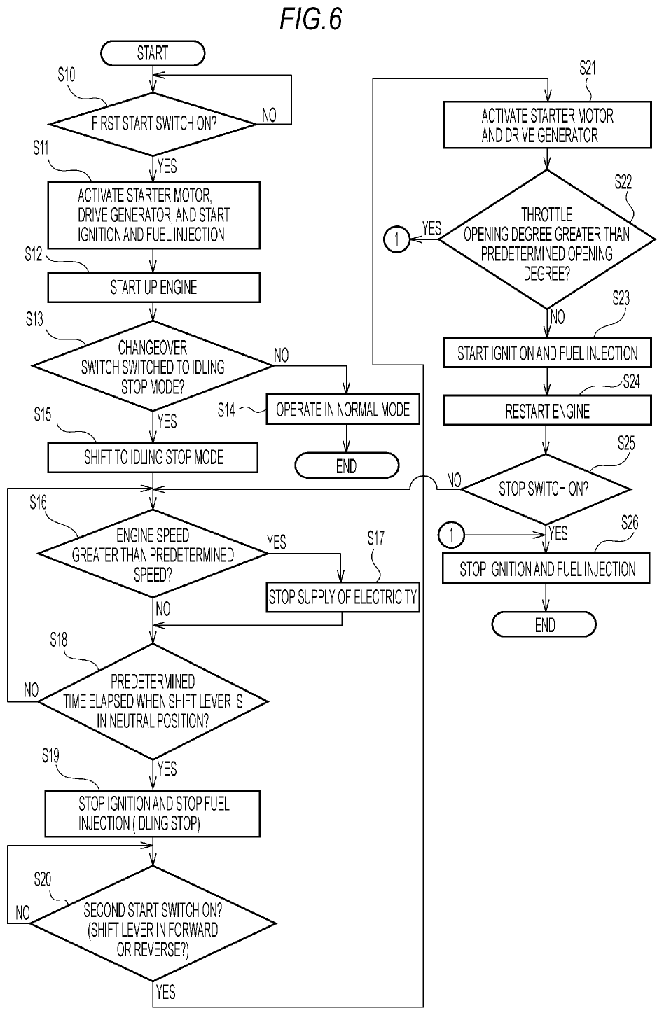

Next, the operation of the outboard motor 10 centering on the idling stop function will be described with reference to a flowchart of FIG. 6. The flowchart of FIG. 6 starts when the engine 18 is in the completely stopped state, the changeover switch 32 is set to the normal mode, the shift lever 36 is in the neutral position, and the neutral switch 58 is closed. Further, in the flowchart of FIG. 6, processing to be performed by the engine control device 50 can be realized, for example, by executing a program stored in a memory of the engine control device 50.

As mentioned above, the outboard motor 10 is not provided with a battery that supplies electric power to the engine accessories such as the engine control device 50. The capacitor 55 maintains the state of being stored in the previous operation.

In step S10, it is determined whether the first start switch 35 is operated by the ship operator. If the first start switch 35 is operated, the processing proceeds to step S11. When not operated, the operation is waited for.

In step S11, by operating the first start switch 35, electric power is supplied from the capacitor 55 to the starter motor 54 as mentioned above, and the starter motor 54 is activated. Accordingly, the starter motor 54 rotates the crankshaft to drive the generator 20. Generated electric power is supplied to the engine control device 50, the ignition device, the fuel injection device, and the like. The engine control device 50 causes the ignition device to start ignition and causes the fuel injection device to start fuel injection.

In step S12, the engine control device 50 causes the engine 18 to start an operation in the normal mode. The engine control device 50, the ignition device, the fuel injection device, and the like are driven only by electric power generated by the generator 20. The capacitor 55 is charged by the generated electric power.

In step S13, it is determined whether the changeover switch 32 has been switched to the idling stop mode. If the switching to the idling stop mode is determined, the processing proceeds to step S15. If the normal mode is held, the processing proceeds to step S14.

In step S14, the engine control device 50 continues the operation in the normal mode and terminates the processing related to the idling stop function.

In step S15, the switching of the changeover switch 32 to the idling stop mode comes into connection of the changeover switch 32 to the contact F and the contact G in the second circuit, thereby causing the engine control device 50 to shift to the idling stop mode.

In step S16, the engine control device 50 receives the engine speed information from the crank angle sensor 52, and determines whether the engine speed is greater than a predetermined speed. Here, the predetermined speed is, for example, the number of revolutions at the time of idling, and is stored in advance in the memory of the engine control device 50. If the engine speed is greater than the predetermined speed, the processing proceeds to step S17. If not, the processing proceeds to step S18.

In step S17, the engine control device 50 performs control to supply current to the coil 57a of the cutoff relay 57 to open the switch 57b, thereby cutting off the supply of electricity from the capacitor 55 to the starter motor 54. When the changeover switch 32 is in the idling stop mode, the changeover switch 32 is connected to the second circuit. In this case, when the ship operator operates the shift lever 36 from the neutral position, the second start switch 59 is closed and current flows from the capacitor 55 to the coil 56a of the starter relay 56 via the second circuit. Accordingly, although the engine 18 is already started up, the switch 56b of the starter relay 56 is closed. Electric power is supplied from the capacitor 55 to the starter motor 54 and the starter motor 54 is activated. Therefore, by cutting off the supply of electricity from the capacitor 55 to the starter motor 54, the starter motor 54 can be prevented from being activated each time the shift lever 36 is operated from the neutral position.

In step S18, the engine control device 50 determines whether the conditions for shifting to the idling stop mode are satisfied. Specifically, the engine control device 50 determines whether a predetermined time has elapsed in the state where the shift lever 36 is in the neutral position. The predetermined time is stored in advance, for example, in the memory of the engine control device 50. If the predetermined time has elapsed, the processing proceeds to step S19. If not, the processing returns to step S16.

In step S19, the engine control device 50 causes the ignition device to stop ignition and further causes the fuel injection device to stop fuel injection, thereby bringing the engine 18 into the idling stop state in which the engine 18 is temporarily stopped. In the idling stop state, no electric power is generated by the generator 20 because the engine 18 is stopped. Further, since the outboard motor 10 is not equipped with a battery that supplies electric power to the engine accessories such as the engine control device 50, no electric power is supplied to the engine control device 50. Accordingly, it is possible to reduce or eliminate power consumption during the idling stop.

In step S20, it is determined whether the shift lever 36 has been operated from the neutral position by the ship operator, that is, whether the second start switch 59 interlocked with the shift lever 36 has been operated. If the second start switch 59 has been operated, the processing proceeds to step S21. If not, the engine control device 50 continues the idling stop and waits for the operation of the second start switch 59.

In step S21, by operating the second start switch 59, electric power is supplied from the capacitor 55 to the starter motor 54 as mentioned above, and the starter motor 54 is activated. Accordingly, the starter motor 54 rotates the crankshaft to drive the generator 20. Generated electric power is supplied to the engine control device 50, the ignition device, the fuel injection device, and the like. At this time, as mentioned above, the second start switch 59 is closed in the middle of the movement range of the dog latch 41 that moves from the neutral position to the engagement position. If the second start switch 59 is closed when the dog latch 41 has moved to the engagement position, resistance by the propeller 29 to rotate the crankshaft may be added. Accordingly, by causing the second start switch 59 to close in the middle of the movement range of the dog latch 41 from the neutral position to the engagement position, power consumption required to activate the starter motor 54 can be reduced.

In step S22, the engine control device 50 receives information on the throttle opening degree from the throttle position sensor 53 and determines whether the throttle opening degree is greater than a predetermined opening degree. Here, the predetermined opening degree is, for example, the throttle opening degree at the time of idling (minimum opening degree), and is stored in advance in the memory of the engine control device 50. At this point, the engine control device 50 is in a state before starting the ignition by the ignition device and the fuel injection by the fuel injection device. Accordingly, the engine control device 50 and the throttle position sensor 53 operate using only the electric power generated when the starter motor 54 rotates the crankshaft in step S21. If the throttle opening degree is greater than the predetermined opening degree, the processing proceeds to step S26. That is, when the throttle opening degree is greater than the predetermined opening degree, the engine control device 50 performs control to prevent the engine 18 from starting, in order to eliminate sudden jumping out. On the other hand, if the throttle opening degree is not greater than the predetermined opening degree, the processing proceeds to step S23.

In step S23, the engine control device 50 causes the ignition device to start ignition and causes the fuel injection device to start fuel injection.

In step S24, the engine control device 50 restarts the engine 18. In this manner, when restarting the engine 18 after the idling stop, the ship operator is not required to operate the first start switch 35, and the engine 18 is restarted in conjunction with the operation of the shift lever 36. Accordingly, since the engine 18 can be restarted only by operating the shift lever 36, the operability when restarting the engine 18 can be improved.

In step S25, the engine control device 50 determines whether the stop switch 33 has been operated by the ship operator. If the stop switch 33 is operated, the processing proceeds to step S26. If not, the processing returns to step S16.

In step S26, the engine control device 50 causes the ignition device to stop the ignition and further causes the fuel injection device to stop the fuel injection, thereby completely stopping the engine 18.

As described above, the outboard motor 10 according to the present embodiment is not equipped with a battery that supplies electric power to the engine accessories, but includes the capacitor 55 that is used only for supplying electric power to activate the starter motor 54. Therefore, compared with a case where a battery is included, the power source of the starter motor 54 can be miniaturized. Therefore, even when the outboard motor 10 according to the present embodiment has the idling stop function, the size of the outboard motor 10 can be miniaturized by arranging the capacitor 55 in the engine compartment 17a.

Further, in the present embodiment, at the time of restarting after the idling stop, the starter motor 54 is activated in conjunction with the shift lever 36 that is directly operated by the ship operator for switching shifts. Since the operation part to be initially operated by the ship operator at the time of restarting after the idling stop is the shift lever 36, not only the operability can be improved but also the outboard motor 10 can be driven quickly by activating the starter motor 54 in conjunction with the shift lever 36.

Further, in the normal mode, the operations required to drive the outboard motor 10 include three operations of operating the first start switch 35, operating the shift lever 36, and rotating the throttle grip 31. On the other hand, in the idling stop mode, the operations required to drive the outboard motor 10 include only two operations of operating the shift lever 36 and rotating the throttle grip 31. Therefore, the outboard motor 10 can be quickly driven again. In particular, when performing drift-fishing, the outboard motor 10 is driven at a very low speed with a low load by only operating the shift lever 36, without rotating the throttle grip 31, thereby causing the hull 1 to propel in an intended direction, in many cases. Accordingly, activating the starter motor 54 in conjunction with the shift lever 36 can perform restarting with an operation capable of realizing a low-load propulsion power and can improve the operability.

Further, in the present embodiment, when the engine speed is greater than the predetermined speed, the switch 57b of the cutoff relay 57 cuts off the supply of electricity from the capacitor 55 to the starter motor 54. Providing the switch 57b of the cutoff relay 57 cutting off the supply of electricity from the capacitor 55 to the starter motor 54 can prevent the starter motor 54 from being activated each time the shift lever 36 is operated from the neutral position, in the idling stop mode, even when the engine 18 is already started up. Accordingly, unnecessary consumption of electric power can be prevented, and failure of the starter motor 54 can be prevented.

Further, in the present embodiment, the second start switch 59 activates the starter motor 54 in the middle of the movement range of the dog latch 41 of the shifting device that moves, according to an operation of the shift lever 36, from the neutral position to the engagement position where the dog latch 41 engages the forward gear 26 or the reverse gear 27. Accordingly, since the starter motor 54 can rotate the crankshaft before the resistance by the propeller 29 is added, the power consumption required to activate the starter motor 54 can be reduced and reliable restarting can be realized.

Further, in the present embodiment, even when the second start switch 59 is operated after the idling stop, the engine control device 50 performs control to prevent the restarting if the throttle opening degree is greater than the predetermined opening degree. If restarting occurs when the throttle opening degree is greater than the predetermined opening degree, sudden jumping out of the hull 1 may occur due to rapid acceleration of the engine 18. Accordingly, performing the control to prevent the restarting can prevent the sudden jumping out of the hull 1 when the throttle opening degree is greater than the predetermined opening degree.

Further, in the present embodiment, in addition to the manual starter, the engine accessories driven only by electric power generated when the engine 18 is operating are included. The engine accessories include the engine control device 50, the ignition device, and a fuel supply apparatus. Accordingly, the power consumption of the capacitor 55 can be further reduced because no electric power is required except at the time of starting the engine 18. Since the power consumption of the capacitor 55 can be reduced in this manner, the capacitor 55 can be miniaturized. Therefore, since the capacitor 55 can be compactly disposed in the engine compartment 17a of the outboard motor body 13, the size of the outboard motor 10 can be reduced.

Further, the capacitor 55 is higher in charging speed compared to the battery. For example, the charging time is several seconds to several minutes. Accordingly, the capacitor 55 is most suitable as a power source for the idling stop function that frequently repeats charging and discharging. Although the capacitor is conventionally used as a power source of the starter, the capacitor has a structure capable of serving as a power supply for a control device. Therefore, when shifted to the idling stop, electric power charged in the capacitor is supplied to the control device. On the other hand, in the present embodiment, after the idling stop, the engine accessories including the engine control device 50 are brought into a standby state and therefore it is unnecessary to supply electric power. The unnecessity of supplying electric power to the engine accessories including the engine control device 50 in the idling stop state makes the capacitor 55 free from management of electric power.

It should be noted that the above embodiment merely illustrates a concrete example of implementing the present invention, and the technical scope of the present invention is not to be construed in a restrictive manner by this embodiment. That is, the present invention may be implemented in various forms without departing from the technical spirit or main features thereof.

For example, although the power source used in the above-mentioned embodiment is the capacitor 55, the present invention is not limited to this case. For example, the capacitor 55 may be combined as an auxiliary power supply with the battery.

Further, in the above-mentioned embodiment, the operation part directly operated by the ship operator is the shift lever 36. However, the present invention is not limited to this case. For example, the operation part may be the throttle grip 31.

According to the present invention, the outboard motor can be miniaturized even in the case of having the idling stop function.

What is claimed is:

1. An outboard motor having an idling stop function comprising:
an electric starter configured to start up an engine;
a capacitor configured to serve as a power source of the electric starter;
a restarting circuit that includes a restart switch configured to activate the electric starter by electric power supplied from the capacitor in conjunction with an operation part directly operated by a ship operator at a time of restarting after idling stop;
a changeover switch configured to switch to an idling stop mode that enables the restarting circuit; and
a control unit configured to control shifting to the idling stop in the idling stop mode,
wherein the capacitor is disposed in an engine compartment of the outboard motor.

2. The outboard motor according to claim 1, further comprising
a shift lever configured to switch shifts as the operation part directly operated by the ship operator,
wherein the restart switch activates the electric starter in conjunction with an operation of the shift lever.

3. The outboard motor according to claim 2, further comprising:
a speed detection unit configured to detect engine speed; and
a cutoff switch configured to cut off supply of electricity from the capacitor to the electric starter when the engine speed detected by the speed detection unit is greater than a predetermined speed.

4. The outboard motor according to claim 2, wherein
the restart switch activates the electric starter in a middle of a movement range when a clutch of a shifting device moves from a neutral position to an engagement position where the clutch engages with a forward gear or a reverse gear in accordance with the operation of the shift lever.

5. The outboard motor according to claim 1, further comprising
an opening degree detection unit configured to detect a throttle opening degree,
wherein the control unit performs control to prevent the restarting when the throttle opening degree detected by the opening degree detection unit is greater than a predetermined opening degree, even when the restart switch is operated after the idling stop.

6. The outboard motor according to claim 1, further comprising:
a manual starter; and
engine accessories driven only by electric power generated when the engine is operating,
wherein the engine accessories include the control unit, an ignition device, and a fuel supply apparatus.
